(19) United States
(12) Patent Application Publication
(10) Pub. No.: US 2010/0262487 A1
(43) Pub. Date: Oct. 14, 2010

(54) CONTEXTUAL TARGETING BASED UPON CUSTOMER OCCASIONS

(75) Inventors: Duane Stephen Edwards, Bellevue, WA (US); Cullen Robert Davidson, Seattle, WA (US)

Correspondence Address: FROMMER LAWRENCE & HAUG, 745 FIFTH AVENUE- 10TH FL., NEW YORK, NY, 10151, US

(73) Assignee: Globys Inc., Seattle, WA (US)

(21) Appl. No.: 12/755,063

(22) Filed: Apr. 6, 2010

Related U.S. Application Data
(60) Provisional application No. 61/167,104, filed on Apr. 6, 2009.

(51) Int. Cl. G06Q 30/00; H04M 11/00; G06Q 10/00; G06Q 50/00

(52) U.S. Cl. 705/14.43; 455/405; 705/14.52

(57) ABSTRACT

Embodiments are directed towards enabling telecommunications networked services providers to maximize sales of products, services, content, and applications to their customers by detecting contextual occasions in which to present a customer an offering of a product, service, content, or application. The occasion may be defined for the customer within their cultural environment by ethnographic research and anthropological modeling. The occurrence of a contextual occasion may be realized for a customer, in part, based on predictive and behavioral analytics of demographic, behavioral, and/or psychographic customer attributes. The customer's activities, location, time, social network activity, and events occurring in the world are also monitored to identify or predict an occurrence of the targeted occasion in which to present a contextually relevant product, service, content, and/or application offering to the customer.

### CROSS-REFERENCE TO RELATED APPLICATIONS

This application claims the benefit of U.S. Provisional Application Ser. No. 61/167,104 entitled “Telecom Carrier Personalizations Based On A User Occasion,” filed on 6 Apr. 2009, the benefit of the earlier filing date of which is hereby claimed under 35 U.S.C. §119 (e) and which is further incorporated herein by reference.

### TECHNICAL FIELD

The present invention relates generally to providing targeted offerings to a telecommunications customer and, more particularly, but not exclusively to using personalized, contextual targeting to an occasion when the customer is predicted to have a high emotional stake in a product or service and therefore be receptive to a selectively targeted offer based on demographic, behavioral, and/or psychographic user attributes, tracked user activities, times and/or places, social network activity, and/or other events occurring in the customer's network data or in the world.

### BACKGROUND

The dynamics in today's telecommunications market are placing more pressure than ever on networked services providers to find new ways to compete. With high penetration rates and many services nearing commoditization, many companies have recognized that it is more important than ever to find new ways to bring the full and unique value of the network to their customers. In particular, these companies are seeking new solutions to help them more effectively up-sell and/or cross-sell their products, services, content, and applications, successfully launch new products, and create long-term value in new business models.

One traditional approach for marketing a particular product or service to telecommunications customers includes advertisement campaigns that are launched by telecommunications networked services providers through a variety of communication channels directed towards these potential purchasers to attempt to convince them that they need the latest product. However, such approaches may be ignored by the customers as being irrelevant.

Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device that may be included in a system implementing the invention;

FIG. 3 shows one embodiment of a network device that may be included in a system implementing the invention; and

FIG. 4 shows one embodiment of a contextual marketing architecture useable to perform intelligent prediction of a customer target occasion for contextual networked services provider offerings to be pushed to the customer based on detection of the target occasion;

FIG. 5 illustrates one embodiment of an overview of a process for intelligent prediction of a customer target occasion for contextual networked services provider offerings pushed to the customer based on detection of the target occasion;

FIG. 6 illustrates one non-limiting, non-exhaustive example of an occasion and related conditions as researched by ethnographical analytics and anthropological occasion modeling;

FIG. 7 illustrates one non-limiting, non-exhaustive example of conditions used to define an occasion as researched by anthropological/ethnographical analytics; and

FIG. 8 illustrates one embodiment of data analysis useable to detect the occurrence of an occasion.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed, as limited to the embodiments set forth herein; rather, these embodiments are provided so that this disclosure will be thorough and complete, and will fully convey the scope of the invention to those skilled in the art. Among, other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “customer” and “subscriber” may be used interchangeably to refer to an entity that has or is predicted to in the future make a procurement of a product, service, content, and/or application from another entity. As such, customers include not just an individual but also businesses, organizations, or the like.

As used herein, the terms “networked services provider”, “telecommunications”, “telecom”, “provider”, “carrier”, and “operator” may be used interchangeably to refer to a provider of any network-based telecommunications media, product, service, content, and/or application, whether inclusive of or independent of the physical transport medium that may be employed by the telecommunications media, products, services, content, and/or application. As used herein, references to “products/services,” or the like, are intended to include products, services, content, and/or applications, and is not to be construed as being limited to merely “products and/or services.” Further, such references may also include scripts, or the like.

As used herein, the term “ethnographic” refers to those characteristics of human society that are directed towards specific cultural aspects of the society. As used herein then, ethnographic analysis and/or ethnographic research processes are applied to various people to identify cultural and behavioral characteristics of the people. These characteristics may then be employed to identify a set of occasions for a particular cultural grouping of people, where each occasion is defined by a set of conditions or states. In one embodiment, ethnographic analysis is a subset of analysis performed within an anthropological context.

As used herein, the term “condition” refers an outcome to one or more tests, answers, or circumstances that are evaluated to determine whether the condition is present. Thus, for example, a condition may be defined based on one or more circumstances that define an answer to “who,” “what,” “where,” “when,” “how,” “how often,” and/or similar questions.

As used herein, the term “occasion” refers to an event state within a person's life where the person is likely to have an elevated emotional stake in an outcome of the related event. Occasions are defined by one or more conditions. That is, an occasion is defined as a situation in which the telecommunications customer is predicted to have a high emotional stake in the product/service and therefore be receptive to a selectively targeted offer based on that situation. Occasions may, in one embodiment, be identified using telecommunications network services providers data that includes but is not limited to demographic, behavioral, and/or psychographic user attributes, tracked user activities, times and/or places, social network activity, and/or other events occurring in the customer's data.

As used herein, the terms “optimized” and “optimal” refer to a solution that is determined to provide a result that is considered closest to a defined criteria or boundary given one or more constraints to the solution. Thus, a solution is considered optimal if it provides the most favorable or desirable result, under some restriction, compared to other determined solutions. An optimal solution therefore, is a solution selected from a set of determined solutions.

As used herein, the terms “offer” and “offering” refer to a networked services provider's product, service, content, and/or application for purchase by a customer. An offer or offering may be presented to the customer using any of a variety of mechanisms. Thus, the offer or offering is independent of the mechanism in which the offer or offering is presented.

As used herein, the terms “touch point” and “channel” refer to a situation or event in which a networked services provider and customer may interact for a purchase of a product/service based on an offer or offering or interact for other purposes such as answering a customer's question. Touch points or channels therefore may include a particular mechanism in which the offer/offering may be presented, such as within an advertisement, service bulletin, or the like, or via a message that is pushed to the customer, or the like.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some, concepts in a simplified form as a prelude to the more detailed description that is presented later.

Briefly stated, embodiments are directed towards enabling networked services providers to maximize sales of products, services, content, and/or applications to their customers by detecting contextual occasions for which arises an opportunity to present the customer an offering. The contextual occasion may be defined for a customer, in part, based on ethnographic characteristics that are determined in part based on various demographic, behavioral, and/or psychographic customer attributes. Then a customer's activities, location, a time, social network activities, events occurring in the world, including but not limited to news, sports, weather, stocks, and traffic, and the like, are monitored to detect the occurrence of an occasion in which to present the customer an offer.

To enable networked services providers to maximize revenues-from-current customers, the present invention is directed towards exploiting the intelligence about a customer using data that the networked services providers may already have and/or are uniquely positioned to obtain. Networked services providers are uniquely positioned with rich, valuable data about their customers—including who the customers are, where they are, and how they historically have behaved. Armed with such real-time contextual data, and one-to-one contextual targeting, networked services providers may proactively address the right customer at the right time with a contextual offering of a product, service, content, or application.

As disclosed, telecommunications networked services providers have a unique position in a customer's communication chain. That is, the networked services providers directly provide network access time, networked devices, and other services that are continuously monitored for use. Such unique position enables networked services providers to track time usage, location, type of communications used, roaming, and other direct product/service usage indicators. This provides the networked services providers with direct and robust customer intelligence. They know how, when, and where a customer uses their products, services, content, and applications. They know which content and applications are downloaded, and where and when such events occur. The networked products/services providers obtain such information directly from behavior information from the customers as an integral part of the services provided to the customer. Therefore, they know whether the customer uses mobile internet services, roaming, perform searches, enables location tracking, as well as how connected a customer is to other customers, and/or how early or late a particular customer tends to adopt a new product/service.

Moreover, because of the networked services provider's billing relationship with a customer, they have access to records of purchases, both of the networked services provider's own products, services, content, and applications as well as purchases of third-party products/services billed through the networked services provider.

The networked services provider may also obtain robust customer-specific profiles that are developed based on intelligence that extends beyond demographics. For example, psychographies, usage behavior, product purchase tendencies, click-through history, social connectedness are all immediately available to measure and define each customer and in conjunction with contextual information, what their needs are at a given moment in time, location, and the like.

The networked services provider may use this rich customer data to identify occasions to present to a customer a contextual offering. The data may be analyzed using statistical analysis and predictive analytics to identify a plurality of occasions. As noted above, the occasions may include various conditions based on, for example, “who” the customer is, “what” the customer needs or is doing, “when” the occasion occurs, “where” the occasion occurs, and “why” the occasion is relevant to the customer. The occasions may be periodically filtered, and refined using various statistical analyses and ethnographic research to determine confidence levels associated with conditions within each occasion. In one embodiment, occasions, related conditions, and confidence levels are revised and/or refined based onion-going research and analysis of historical data.

The occasions, along with their associated conditions and confidence levels, are provided to an occasion engine within a contextual marketing platform. The occasion engine receives data from the networked services provider for a plurality of customers. The occasion engine monitors the received data for the plurality of customers to detect and/or predict an occurrence of an occasion for any given customer. In one embodiment, the received data represents historical data as well as real-time data. In another embodiment, the occasion engine might not receive information about a particular customer's real-time activities. Instead, the occasion engine may employ the historical data to predict an occurrence of an occasion. For example, based on historical data about a particular customer, the occasion engine may determine a pattern of activity for the customer that indicates an occasion can be predicted to occur at or about a given time, location, or the like, within a given confidence level.

When an occasion is identified or predicted to occur within given confidence level(s), the occasion engine provides information to an optimizer component within the contextual marketing platform. The optimizer component then determines a best offer to be presented to the customer given the detected occasion. In one embodiment, the offer provided to the customer is that offer determined from a plurality of offers having a highest likelihood of being accepted by the customer (e.g., being purchased). In one embodiment, a threshold value is employed such that if no offer is determined to have a likelihood of being accepted above the threshold, then no offer is presented to the customer. Thus, unlike other approaches that provides at least one offer to the customer independent of a likelihood of being accepted, or still other approaches that provide offers merely based on a location—and devoid of virtually any determined likelihood of acceptance, the present invention selects not to provide any offer if none satisfies the threshold for acceptance. In one embodiment, an offer might be determined as an optimal or best offer among a set of determined offers where the offer maximizes the purchase likelihood by the customer.

In other approaches, however, some media and telecommunication providers have attempted to identify where a particular mobile customer is currently located and to provide their product or service offering to the customer based on the customer's immediate location. However, merely detecting where a particular mobile customer is currently located often is not sufficient. The mobile customer may simply not be receptive to an offering based merely on their location, and/or their prior purchasing trends. For example, the customer may be at that location for reasons unrelated to the product/service being offered. Thus, by providing a contextual offer for a product service, content, or application during an occurrence of an occasion where the customer is likely to have an emotional stake for acceptance and/or change, there is also an increased likelihood for acceptance of the offering by the customer over other approaches, such as those discussed above.

One non-limiting example may illustrate the networked services provider's unique position. Many mobile, providers offer applications that allow customers to track the location of friends and family. These applications are often promoted through mass marketing as a way for parents to keep track of the location of their teenage children. Consider a mobile customer, Mary. Mary is on a family plan that includes three other individuals. Mary has a smart phone that is capable of running the family locator application. Mary has purchased mobile applications in the past and has typically done so on weekends. Mary also works a swing shift from 1 PM to 10 PM on weekdays. Mary's mobile provider knows that she has a family plan, knows that she has a smart phone, and knows her purchase history. It also knows when and from where she has made calls, sent text messages, and used data services. Based on the collected information, a prediction can be made within given confidence level(s) of when Mary may be sleeping, when she is likely to be home, when she is likely to head out to work, as well as when she is likely to return from work. Her mobile provider also knows when and from where the family locator application has been purchased by other customers. Using statistical analysis and/or ethnographic research, the mobile networked services provider can determine, for example, that most purchases and usage of a family locator application are determined to occur on Friday and Saturday evenings when a customer is at home. Moreover, ethnographic research may identify that the product is most valuable to parents when they call their children during the weekends to monitor their safety and well-being. Therefore, based on such events, and other data, this contextual occasion for Mary may then be predicted to occur on a Saturday evening—that is, she has a family plan with more than two phones, which statistical modeling may indicate to be a predictor for purchases of family locator applications. She has a smart phone, she has purchased mobile applications, and she is likely to be at home on Saturday evening, when other customers have most frequently purchased the family locator application. Thus, the networked services provider is able to uniquely detect a targeted occasion, and provide a contextual offer based on an occasion that has a specific need for the provider's products, services, content, and applications. As illustrated here, the offer is relevant to Mary, and thus, Mary is more likely to accept it. Thus, networked services providers are able to predict such contextual target occasions and present items such as widgets, video, ads, coupons, and other offerings for products/services, when it is determined that the customer is predicted to have a high emotional stake in the situation. Moreover, consumers are protected from non-relevant and untimely ‘spam’ so that they have a better overall perception of the provider. Additionally, as may be seen such occasions include more conditions than merely a location of Mary (the customer). It may also include a time condition, as well as other ethnographical characteristics about the customer.

Contextual, occasion-based targeting may be viewed as existing at the intersection of multiple modern sciences: anthropology, predictive and ethnographic behavioral analytics, and communications networks. Research and technology is brought together to reach customers across networks of millions with the right offer, at the right time, place, and emotional context.

The present invention employs a variety of technologies, each with a distinct role. Anthropologic or ethnographic modeling and research is employed, for example, to identify the right occasions to target for a given group of people. Predictive and behavioral analytics are used to find the data patterns for targeting the occasions for the group of people, and in particular, a given individual within the group. In addition, modern software technologies and computing power provide the ability to track and/or predict occasions and to selectively deliver upon them across millions of active and, networked individuals.

Thus, the present invention discloses a suite of contextual marketing solutions that are arranged to enable networked services providers to increase adoption and usage of relevant products, services, content, and applications, accelerate mobile data penetration into a mass market, and reinvent their mobile advertising models through contextual targeting. As disclosed, an analytical approach using demographic, behavioral, and/or psychographic customer attributes is used to identify target occasions that predict a specific customer need having a determined higher emotional stake in a situation over other situations previously identified for the specific customer, and to drive demand for products, services, content, or applications. Targeting is based on detecting a customer specific occasion—who a customer is, and the context that includes time, place, and/or channel, as well as based on a particular usage and purchases by the customer of the networked services provider's offerings. Employing rich customer intelligence to define customer-specific target occasions and using real-time targeting capabilities to predict and target the occasion enables the networked services provider's network to drive solutions that are directed towards adding value to a customer and putting the networked services provider's network at the heart of the customer's lifestyle, without having to wait until the customer takes action to seek the product/service.

Many opportunities to present an offer tend to be reactive, meaning that products, services, content, and applications are'traditionally promoted through customer-initiated interactions. However, a networked services provider is able to provide contextual targeting to proactively push their offerings, at a specific time a customer is most likely to value it. Thus, with contextual targeting, the networked services provider may identify a target occasion for a specific customer, monitor for the occurrence of the target occasion, and, when it is detected/predicted, selectively present a product/service to the customer that is relevant to the target occasion. The offer, advertisement, or alert brings forward a networked, services provider's product/service at a time when a customer is mostly likely to be receptive to it as determined by customer specific threshold(s).

Although the invention is described for use by telecommunications networked services providers, the invention is not so limited. Thus, for example, other market products, such as vehicles, vehicle add-ons, client computing devices, eyewear, accounting, or virtually any other marketable product, service, content, or application space may employ embodiments of the invention, without departing from the scope of the invention.

### Illustrative Operating Environment

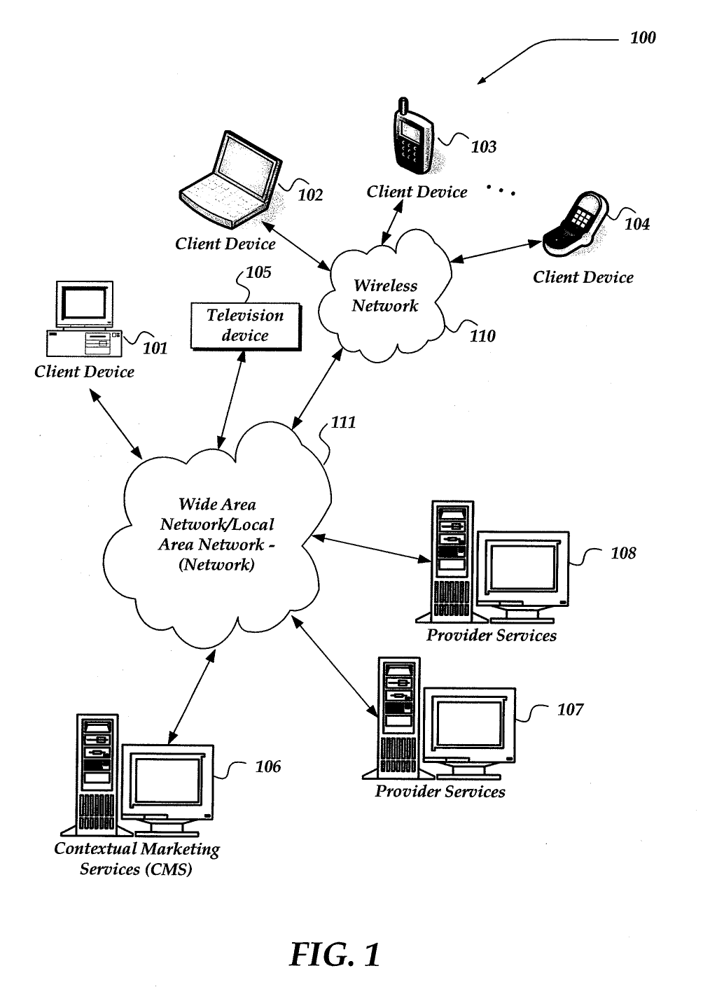

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 111, wireless network 110, client devices 101-105, Contextual Marketing Services (CMS) 106, and provider services 107-108.

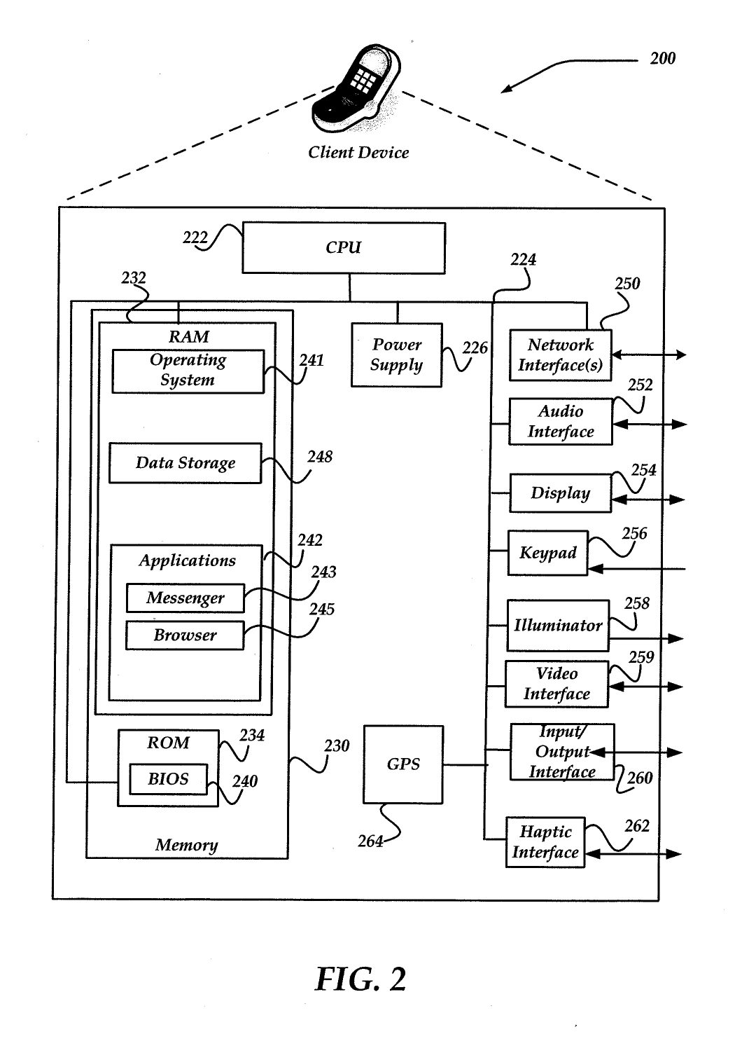

One embodiment of a client device usable as one of client devices 101-105 is described in, more detail below in conjunction with FIG. 2. Generally, however, client devices 102-104 may include virtually any computing device capable of receiving and sending a message over a network, such as wireless network 110, wired networks, satellite networks, virtual networks, or the like. Such devices include wireless devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client device 101 may include virtually any computing device that typically connects using a wired communications medium such as telephones, televisions, video recorders, cable boxes, gaming consoles, personal computers, multiprocessor systems, microprocessor-based or programmable consumer electronics, network PCs, or the like. Further, as illustrated, client device 105 represents one embodiment of a client device operable as a television device. In one embodiment, one or more of client devices 101-105 may also be configured to operate over a wired and/or a wireless network.

Client devices 101-105 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color display in which both text and graphics may be displayed.

A web-enabled client device may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client devices 101-105 also may include at least one other client application that is configured to receive information and other data from another computing device. The client application may include a capability to provide and receive textual content, multimedia information, or the like. The client application may further provide information that identifies itself, including a type, capability, name, or the like. In one embodiment, client devices 101-105 may uniquely identify themselves through any of a variety of mechanisms, including a phone number, Mobile Identification Number (MIN), an electronic serial number (ESN), mobile device identifier, network address, or other identifier. The identifier may be provided in a message, or the like, sent to another computing device.

In one embodiment, client devices 101-105 may further provide information useable to detect a location of the client device. Such information may be provided in a message, or sent as a separate message to another computing device.

Client devices 101-105 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, between another computing device. However, the present invention is not limited to these message protocols, and virtually any other message protocol may be employed.

Client devices 101-105 may further be configured to include a client application that enables the user to log into a user account that may be managed by another computing device. Information provided either as part of a user account generation, a purchase, or other activity may result in providing various customer profile information. Such customer profile information may include, but is not limited to demographic and/or ethnographic information about a customer, and/or behavioral information about a customer and/or a customer's activities. In one embodiment, such customer profile information might be obtained through interactions of the customer with a brick-and-mortar service, or dynamically tracked based on a usage of the networked services provider's products/services. However, customer profile information might also be obtained by monitoring activities such as purchase activities, network usage activities, or the like, over a network.

Wireless network 110 is configured to couple client devices 102-104 with network 111. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation radio access for cellular systems, WLAN, Wireless Router (WR) mesh, or the like. Access technologies such as 2G, 2.5G, 3G, 4G, and future access networks may enable wide area coverage for client devices, such as client devices 102-104 with various degrees of mobility. For example, wireless network 110 may enable a radio connection, through a radio network access such as Global. System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between client devices 102-104 and another computing device, network, or the like.

Network 111 is configured to couple CMS 106, provider services 107-108, and client devices 101 and 105 with other computing devices, including through wireless network 110 to client devices 102-104. Network 111 is enabled to employ any form of computer readable media for communicating information from one electronic, device to another. Also, network 111 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 111 includes any communication method by which information may travel between computing devices.

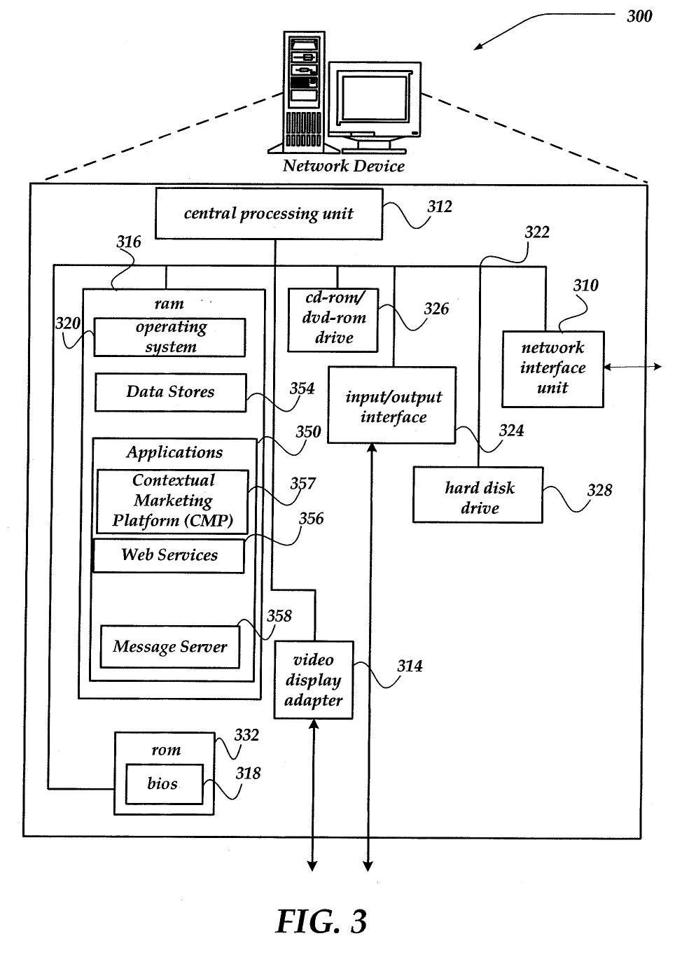

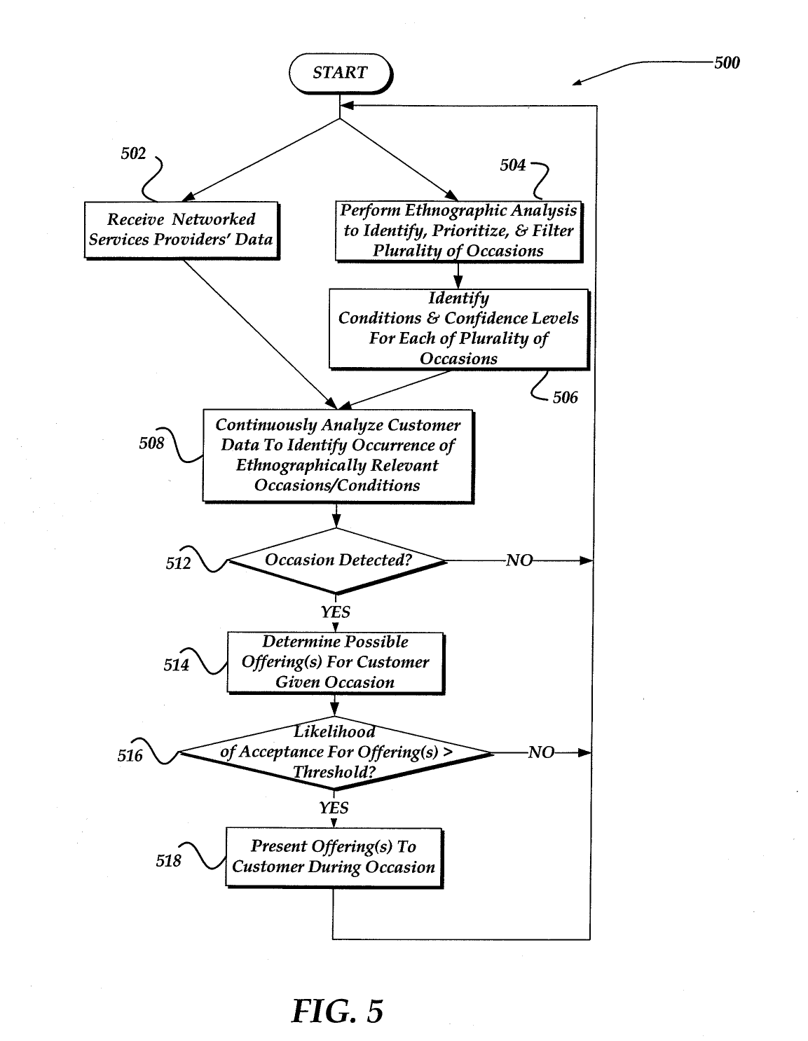

One embodiment of a CMS 106 is described in more detail below in conjunction with FIG. 3. Briefly, however, CMS 106 includes virtually any network computing device that is configured to proactively and contextually target offers to customers based on detection or prediction of a contextual occasion as described in more detail below in conjunction with FIG. 5.

Devices that may operate as CMS 106 include, but are not limited to personal computers, desktop computers, multiprocessor systems, microprocessor-based or programmable consumer electronics, network PCs, servers, network appliances, and the like.

Although CMS 106 is illustrated as a distinct network device, the invention is not so limited. For example, a plurality of network devices may be configured to perform the operational aspects of CMS 106. For example, profile data collection might be performed by one or more set of network devices, while predictive analytics, and/or reporting interfaces, and/or the like, might be provided by another one or more network devices.

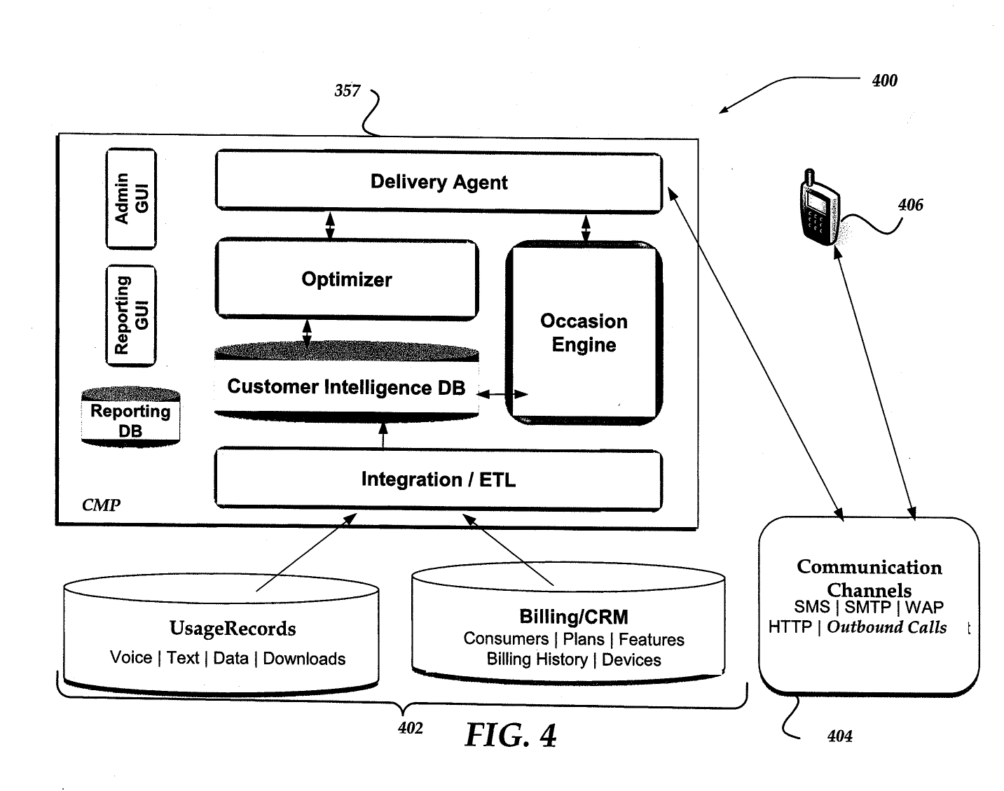

Provider services 107-108 include virtually any network computing device that is configured to provide networked services provider, customer, and other context information useable by CMS 106 for use in generating and selectively pushing or otherwise presenting a customer with targeted customer offers using various touch point mechanisms. Thus, provider services 107-108 may provide various interfaces, including, but not limited to those described in more detail below in conjunction with FIG. 4.

### Illustrative Client Environment

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one of client devices 101-105 of FIG. 1.

As shown in the figure, client device 200 includes a processing unit (CPU) 222 in communication with amass memory 230 via a bus 224. Client device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed, for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged, to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light illuminator 258 may remain active for specific periods of time or in response to events. For, example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like. Haptic interface 262 is arranged to provide tactile feedback to a user of the client device. For example, the haptic interface may be employed to vibrate client device 200 in a particular-way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical, location may be less precise, such as within a meter or significantly greater distances. In one embodiment, however, a client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer readable storage media for storage of information such as computer readable instructions, data structures, program modules, or other data. Computer readable storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Mass memory 230 stores a basic input/output system (“BIOS”) 240 for controlling low-level operation of client device 200. The mass memory also stores' an operating system 241 for controlling the operation of client 200. It will be appreciated that this component may include a general-purpose operating system such as a version of UNIX, or LINUX™, or a specialized client operating system, for example, such as Windows Mobile™, PlayStation 3 System. Software, the Symbian® operating system, or the like. The operating system may include, or interface with a Java virtual machine module that enables control of hardware components and/or operating system operations via Java application programs.

Memory 230 further includes one or more data storage 248, which can be utilized by client device 200 to store, among other things, applications 242 and/or other data. For example, data storage 248 may also be employed to store information that describes various capabilities of client device 200, as well as store an identifier. The information, including the identifier, may then be provided to another device based on any of a variety of events, including being sent as part of a header during a communication, sent upon request, or the like. In one embodiment, the identifier and/or other information about client device 200 might be provided automatically to another networked device, independent of a directed action to do so by a user of client device 200. Thus, in one embodiment, the identifier might be provided over the network transparent to the user.

Moreover, data storage 248 may also be employed to store personal information including but not limited to contact lists, personal preferences, purchase history information, user demographic information, behavioral information, or the like. At least a portion of the information may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may include, for example, messenger 243, and browser 245.

Browser 245 may include virtually any client application configured to receive and display graphics, text, multimedia, and the like, employing virtually any web based language. In one embodiment, the browser application is enabled to employ Handheld. Device Markup Language (HDML), Wireless Markup Language (WML), WMLScript, JavaScript, Standard Generalized Markup Language (SMGL), HyperText Markup Language (HTML), eXtensible Markup Language (XML), and the like, to display, and send a message. However, any of a variety of other web-based languages may also be employed.

Messenger 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 243 may be configured as an IM application, such as AOL Instant Messenger, Yahoo! Messenger, .NET Messenger Server, ICQ, or the like. In one embodiment messenger 243 may be configured to include a mail user agent (MUA) such as Elm, Pine, MH, Outlook, Eudora, Mac Mail, Mozilla Thunderbird, or the like. In another embodiment, messenger 243 may be a client application that is configured to integrate and employ a variety of messaging protocols. Messenger 243 and/or browser 245 may be employed by a user of client device 200 to receive selectively targeted offers of a product/service based on a detected occurrence of an occasion.

### Illustrative Network Device Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, CMS 106 of FIG. 1.

Network device 300 includes processing unit 312, video display adapter 314, and a mass memory, all in, communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer readable storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. For example, mass memory might include data store 354. Data store 354 may be include virtually any mechanism usable for store and managing data, including but not limited to a file, a folder, a document, or an application, such as a database, spreadsheet, or the like. Data store 354 may manage information that might include, but is not limited to web pages, information about members to a social networking activity, contact lists, identifiers, profile information, tags, labels, or the like, associated with a user, as well as scripts, applications, applets, and the like.

One or more applications 350 may be loaded into mass memory and run on operating system 320. Examples of application programs may include transcoders, schedulers, calendars, database programs, word processing programs, HTTP programs, customizable user interface programs, IPSec applications, encryption programs, security programs, VPN programs, web servers, account management, games, media streaming or multicasting, and so forth. Applications 350 may include web services 356, Message Server (MS) 358, and Contextual Marketing Platform (CMP) 357.

Web services 356 represent any of a variety of services that are configured to provide content, including messages, over a network to another computing device. Thus, web services 356 include for example, a web server, messaging server, a File Transfer Protocol (FTP) server, a database server, a content server, or the like. Web services 356 may provide the content including messages over the network using any of a variety of formats, including, but not limited to WAP, HDML, WML, SMGL, HTML, XML, cHTML, xHTML, or the like. In one embodiment, web services 356 might interact with CMP 357 to enable a networked services provider to track customer behavior, and/or provide contextual offerings based on detection or: prediction of an occasion.

Message server 358 may include virtually any computing component or components configured and arranged to forward messages from message user agents, and/or other message servers, or to deliver messages to a local message store, such as data store 354, or the like. Thus, message server 358 may include a message transfer manager to communicate a message employing any of a variety of email protocols, including, but not limited, to Simple. Mail Transfer Protocol (SMTP), Post Office Protocol (POP), Internet Message Access Protocol (IMAP), NNTP, Session Initiation Protocol (SIP), or the like.

However, message server 358 is not constrained to email messages, and other messaging protocols may also be managed by one or more components of message server 358. Thus, message server 358 may also be configured to manage SMS messages, IM, MMS, IRC, mIRC, or any of a variety of other message types. In one embodiment, message server 358 may also be configured to interact with CMP 357 and/or web services 356 to provide various communication and/or other interfaces useable to receive provider, customer, and/or other information useable to determine and/or provide contextual customer offers.

One embodiment of CMP 357 is described further'below in conjunction with FIG. 4. However, briefly, CMP 357 is configured to receive various historical data from networked services providers about their customers, including customer profiles, billing records, usage data, purchase data, types of mobile devices, and the like. CMP 357 may then perform analysis and related analytics on the received information to identify a plurality of occasions. In one embodiment, CMP 357 employs ethnographic analysis and/or ethnographic research to characterize customers and to identify a plurality of occasions for the customers. CMP 357 may further employ the historical data and ethnographic analysis/research to identify a plurality of confidence levels for the conditions for each occasion.

CMP 357 monitors ongoing historical and/or real-time data from the networked services provider or external sources to detect or predict within a combination of a plurality of confidence levels, when an occasion is likely to occur for particular customers. Then, based on a detected or predicted occurrence of an occasion for a customer, CMP 357 may select an offer targeted to the customer. The selected offer may then be presented to the customer. However, in one embodiment, CMP 357 might determine that no offer is to be presented to the customer based in part on none of the available offers having a likelihood of being accepted by, the customer that exceeds a given threshold. In this manner, the customer is selectively presented with an offer at a time, location, and in an ethnographically defined situation when they are predicted to be most emotionally receptive to the offering, while avoiding sending offers that are likely to not be accepted during the given occasion by the customer. In one embodiment, the given threshold is selected for each customer based on the customer's previous purchases for similar products/services, and the like.

### Illustrative Contextual Marketing Architecture

FIG. 4 shows one embodiment of an architecture useable to perform contextual occasion marketing for contextual offers to be delivered to, the customer based on detection of an occasion occurrence for the customer. Architecture 400 of FIG. 4 may include many more components than those shown. The components shown, however, are sufficient to disclose an illustrative embodiment for practicing the invention. Architecture 400 may be deployed across components of FIG. 1, including, for example, CMS 106, client devices 101-105, and/or provider services 107-108.

Architecture 400 is configured to make selection decisions from statistical and ethnographic behavioral analysis of historical networked services provider's customer usage records, billing data, and the like. Occasions are identified based on the analytics, and monitored to identify and/or predict their occurrence for customers. Offers to the customer during the occurrence of an occasion are optimized according to a customer's interests and preferences as determined by the historical data and the nature of the occasion. Each offer is directed to be optimized to resonate with the customer—highly targeted, relevant, and timely. At the same time, in one embodiment, if for a given customer it is determined that no offer is likely to be accepted by the customer for a given occasion, thermo offer is delivered to the customer. In this manner, the customer is not overwhelmed with unnecessary and undesired offerings. Such unnecessary offerings might be perceived by the customer as spam, potentially resulting in decreasing receptivity by the customer to future offers.

However, in other embodiments, an offer may be optimized according to not only a customer's interests and preferences given the occurrence of an occasion, but the offer may also be optimized according to a provider's revenue and/or profitability potential. For example, where it might be determined that a customer's response is predicted to be similar for two distinct offers, then the provider benefits from a selection of an offer to be presented to the customer that yields a greatest return to the provider. Thus, other selection criteria may also be employed.

In any event, not all the components shown in FIG. 4 may be required to practice the invention, and variations in the arrangement and type of the components may be made without departing from the spirit or scope of the invention. As shown, however, architecture 400 includes a CMP 357, networked services provider (NSP) data stores 402, communication channel or Communication channels 404, and client device 406.

Client device 406 represents a client device, such as client devices 101-105 described above in, conjunction with FIGS. 1-2. NSP data stores 402 may be implemented within one or more services 107-108 of FIG. 1. As shown, NSP data stores 402 may include a Billing/Customer Relationship Management (CRM) data store, and a Network Usage Records data store. However, the invention is not limited to this information and other types of data from networked services providers may also be used. The Billing/CRM data may be configured to provide such historical data as a customer's profile, including their billing history, customer service plan information, service subscriptions, feature information, content purchases, client device characteristics, and the like. Usage Records may provide various historical data including but not limited to network usage record information including voice, text, internet, download information, media access, and the like. NSP data stores 402 may also provide information about a time when such communications occur, as well as a physical location for which a customer might be connected to during a communication. Such physical location information may be determined using a variety of mechanisms, including for example, identifying a cellular station that a customer is connected to during the communication. From such connection location information, an approximate geographic or relative location of the customer may be determined.

In one embodiment, at least three data categories of networked services provider's data may be used, including:
1) Purchase Data: Billing summary data and content purchases provide a view of current ownership, historical purchase trends, and timing of purchases.
2) Usage Data Detailed records of network activity including voice, text, and Internet sessions allow for evaluation of relative locations, movement patterns, historical usage trends, social graphing, and timing, of activities.
3) Profile Data Existing demographic, behavioral, psychographic, segmentation, device, or other attributes or classifications of customers.

This data may be found in existing feeds and flows already coming out of or flowing to mediation, rating, charging, billing, fraud management and/or data warehouse systems, as well as those shown in FIG. 4. In one embodiment, an outbound extract of activity is produced by CMP 357 that allows the networked services provider to maintain a single view of all communication activity to a consumer base.

CMP 357 is streamlined for occasion identification and presentation. Only a small percentage of the massive amount of incoming data is processed immediately due to hierarchical condition predictions and evaluation techniques that limit the need for active monitoring for every condition for every customer. The remaining records may be processed from a buffer to take advantage of processing power efficiently over a full 24 hours. As the raw data is processed into predictive scores, times, statistics and other supporting data, it may be discarded from the system, in one embodiment, leaving a sustainable data set that scales as a function of consumer base.

Additionally, in one embodiment, the scoring technique may devalue data over time, allowing for the influence of data older than three months to be dropped from the resulting score. In this way, historical data is not persisted or maintained beyond three months. However, it should be noted that other time periods may also be selected, including, for example, several days, several weeks, as well as more than three months.

Communication channels 404 include one or more components that are configured to enable network devices to deliver and receive interactive communications with a customer. In one embodiment, communication channels 404 may be implemented within one or more of provider services 107-108, and/or client devices 101-105 of FIG. 1, and/or within networks 110 and/or 111 of FIG. 1.

The various components of CMP 357 are described further below in the table. Briefly, however, CMP 357 is configured to receive customer data from NSP data stores 402. CMP 357 may then employ predictive and behavioral analytics to identify a plurality of conditions. CMP 357 may further use the plurality of conditions to identify a plurality of occasions and associated conditions/states with associated confidence levels for each customer. Such confidence levels may be determined based on, for example, an amount of data, having been analyzed for a given customer, and a desired amount of acceptable error. For example, lower confidence levels may arise where the data for a customer is sparse within a given time period. Higher confidence levels may arise where the data is determined to be more dense (e.g., higher quantity of data within the time period).

CMP 357 then monitors received information for a customer and based on the customer's condition states, identifies or predicts within a combination of confidence levels an occurrence of a relevant occasion. When a relevant occasion, is identified or predicted to occur, CMP 357 may then selectively present to the customer contextual offering of product/service, as appropriate.

In one embodiment, architecture 400 may be designed to take full advantage of modern efficiencies of hardware and software commoditization running on Linux servers with massive horizontal scaling opportunity. Architecture 400 may, in one embodiment, be written using modern Java architectures including Spring and JEE. However, it is understood that other server systems, programming languages, and the like, may also be used. Thus, the invention is not to be construed as being limited to a single server type, operating system, licensed technology, and/or programming language.

As discussed above, CMP 357 employs anthropological/ethnographic processes to understand how and why cultures evolve with technology. This research and analysis enables CMP 357 to identify the best occasions that might drive the adoption of new technologies and services.

In one embodiment, anthropologists work with a regional team of ethnographers to establish detailed recruiting, guidelines for the fieldwork based on the goals for implementation and the cultural specifics of that region. Hundreds of people and related data may be screened to find the few subjects that are ideal for detailed investigation. In one embodiment, at least some of this analysis may be performed through CMP 357.

In one embodiment, ethnographers may include local citizens of the region, trained in ethnographic research practices, who might perform, at least in part, detailed and intimate research with each recruited subject to understand how, when, where and why that person interacts with their client device throughout their daily life. Such results may be incorporated into and/or employ CMP 357. One of the final outputs of the analysis phase is a set of modeled “occasions” ready for use in detecting or predicting an occurrence of an occasion by CMP 1357. As noted, other outputs include ethnographic groups, and classifications of customers into one or more ethnographic groups.

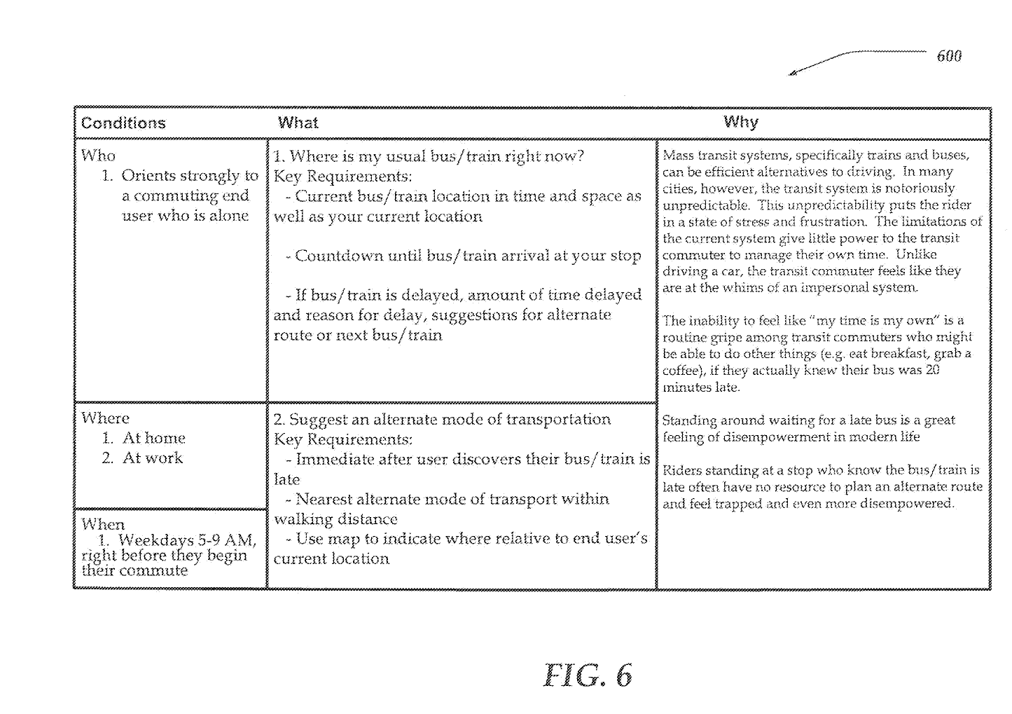

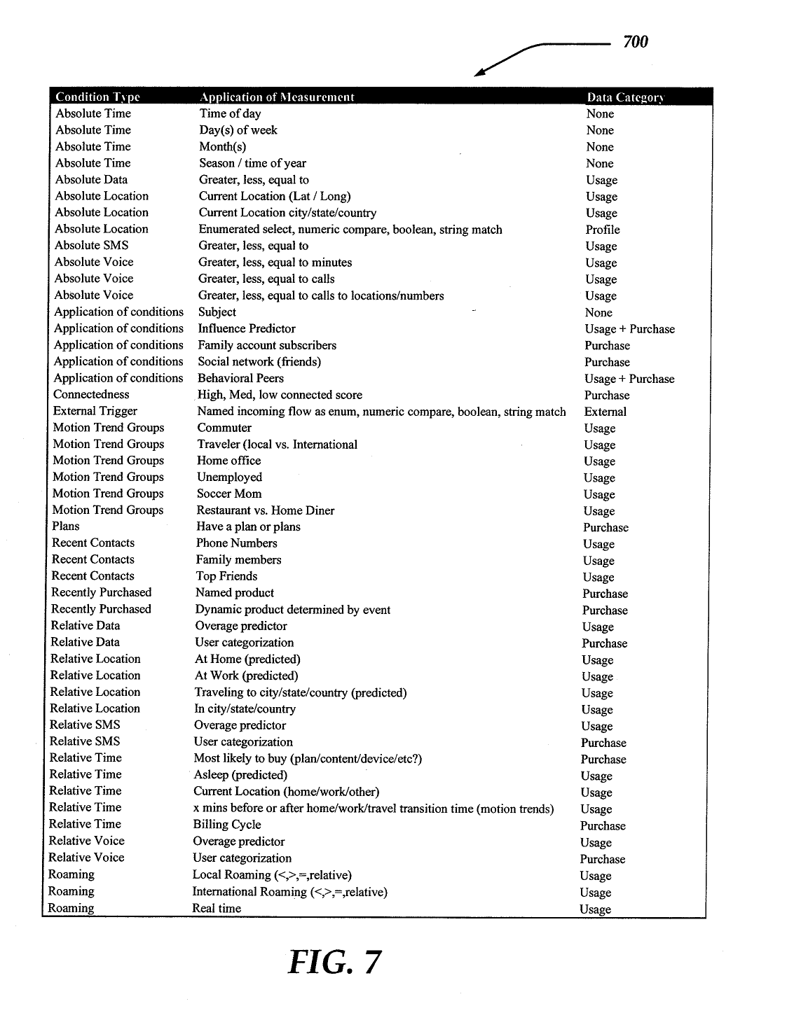

In one embodiment, the occasions are composed of one, or more conditions. Conditions may provide cultural characteristics for such questions, as who, how, what, when, and where. The who, how, what, when, and where that make up an occasion may be derived uniquely for each individual relative to their everyday lifestyle. Non-limiting, non-exhaustive examples of possible occasion conditions are illustrated in FIGS. 6-7.

As an example, suppose a consumer makes approximately twenty or thirty interactions with a network each day. This data leaves a trail of relative locations, times, and habits that can be determined by patterns. Over a course of one day, these interactions are not likely to demonstrate habits, but in even just one week, some individuals demonstrate repeatable patterns from which CMP 357 may identify individual timing and locations such as at home, at work, sleeping, commuting or traveling. Looking at the past-reveals predictions of the future. Based on such patterns, and other characteristics, a customer may then be classified into one or more ethnographic groupings. For example, a customer might be classified into various ethnographic groupings including, harried Commuter, east-coast train commuter, white-collar commuter, stay at home caregiver, or the like. Clearly, other groupings may be provided, and thus, the invention is not to be construed as being, limited to these non-exhaustive examples. In any event, based on the ethnographic groupings and related patterns, various occasions may be identified with measurable conditions. Monitoring the customer's particular information may then enable an occurrence of an occasion for a particular customer.

In one embodiment, the customer data from the networked services provider is received through integration/ETL component, analyzed and stored by the customer intelligence database (DB) component. The resulting conditions, confidence levels, and occasions are provided to the occasion engine.

Additional data for the customers are monitored by the occasion engine to identify or predict an occurrence of an occasion. When the occasion is or predicted to occur, a product or service offer might then be selected for customer for the occasion. The optimizer may perform such selections based on a plurality of criteria, including, but not limited to the characteristics of the occasion, the customer's profile including the customer's purchase history, billing plan and service features, usage records, client device characteristics, the relative value to the network services provider, and the like.

The optimizer may then review each of the plurality of possible offerings to identify whether one or more have a likelihood for acceptance by the customer above a defined threshold. If none is determined to satisfy the threshold, then the optimizer will indicate that no offering is to be presented for the detected occasion. However, if at least one offering has a likelihood of acceptance by the customer above the threshold, optimizer will provide the one or more offerings to the delivery agent for use in pushing the offering to the customer at the time of the occurrence of the occasion.

In another embodiment, the optimizer might select to provide a single offering to the customer to minimize overwhelming the customer with multiple choices. Thus, in one embodiment, where it might be determined that a customer's likelihood of acceptance is predicted to be similar (e.g., the same, or not statistically different) for two distinct offers, then the provider benefits from a selection of an offer to be presented to the customer that yields a greatest return to the provider. Thus, the offer having a greatest return to the provider might be presented to the customer.

The table below provides more details about various components illustrated within FIG. 4. However, it should be recognized that the various components might perform actions and/or provide services in addition to those described below. Thus, the invention is not to be construed as being limited to merely those actions described within the table below.

The occasion engine implements the statistical models that process raw data into scores, confidence, levels, and behavior indicators. The occasion engine also tracks the occasions across the entire consumer base. Once the occasion engine identifies an occasion, for an individual, it triggers an occasion event to be acted upon.

In one embodiment, the occasion engine may be built using a Spring architecture and takes advantage of in-memory processing of occasions. Scalability may, in one embodiment, be achieved horizontally by dynamic partitioning of the subscriber base across available nodes. However, other designs and structures may also be employed.

Acting upon an occasion event requires identifying the right product for that occasion and for that individual. The optimizer uses, in one embodiment, statistically derived propensity models to select the right offer for that customer at that occasion from a catalog of offers that make sense for the occasion.

Persistence of the processed profiles and occasion activity results may be managed within a customer intelligence database (DB), using, for example Oracle RDBMS, or the like. The database is designed to support a streamlined, end-to-end solution that supports evaluating and delivering upon occasions. For this reason, the resulting profiles from the predictive and analytic models are sustainable data set optimized for high volume and speed.

TABLE 1
COMPONENT DESCRIPTIONS

| | | | Integration |
|---|---|---|---|
| Component | Description | Comments | Touch Points |
| Integration/ETL | Loads data from | Typical data sources include: | Data sources |
| | provider and | Data warehouse | integrations via |
| | external data | Customer profile warehouse | files, bus, |
| | sources into | Billing system(s) | stream, API, |
| | customer | CRM system(s) | RSS feed, or |
| | intelligence DB | Network switches | the like. |
| | | Stock quote services | |
| | | Weather services | |
| | | Product catalogs | |
| | | Content Management platforms | |
| | | Data can also flow out of the CMP | |
| | | to update master data sources with | |
| | | information that gets | |
| | | gathered/created/updated via the | |
| | | solution | |
| Customer | Maintains the | Calculates attributes and scores | |
| Intelligence DB | derived | based on the received customer | |
| | customer profile | data | |
| | information | Also can contain info on whether | |
| | including | customers have chosen to opt out | |
| | demographic, | Profiles are also enhanced by data | |
| | behavioral, and | generated by the solution (e.g., | |
| | psychographic | which content the customer | |
| | attributes and | accesses, interests indicated | |
| | scores | through the content, etc.) | |
| Occasion Engine | Maintains the | Definitions for occasions related to | Registration of |
| | definition of the | customer needs | a delivery |
| | occasions - | Custom occasion definition | agent via Web |
| | including the | capability via graphical user | Services |
| | conditions of | interface (GUI), application | |
| | who, how, what, | programmable interface (API), or | |
| | where, and | the like. | |
| | when, as well as | Provider definitions for occasions | |
| | the confidence | related to customer need for | |
| | levels to be | additional products, services, | |
| | satisfied to | content, or applications | |
| | predict/detect an | Self-learning model based on | |
| | occurrence of an | success feedback to refine | |
| | occasion for a | occasions | |
| | customer | | |
| | Monitoring of | | |
| | customer | | |
| | context (when | | |
| | and where) to | | |
| | identify and | | |
| | predict an | | |
| | occurrence of an | | |
| | occasion | | |
| Optimizer | Makes | Determine most appropriate offer | API for |
| | determination of | based upon customer attributes, | requesting |
| | the most | prerequisites, and device | optimized offer |
| | appropriate | capabilities, occasion, and | |
| | offer and | likelihood of acceptance | |
| | determines | thresholds. | |
| | whether | Determines eligibility of customer | |
| | notification | (e.g., whether they should be | |
| | should be sent | notified of occasion) based on | |
| | | acceptance propensity thresholds | |
| | | and/or communication limits | |
| Delivery Agent | Determines the | Message provides overview of | Short Message |
| | appropriate | offer, link to the response | Service Center |
| | delivery | management component, and | Mail Server |
| | Mechanism and | instructions for more information | Web Server |
| | initiates | and/or to opt out | Offer |
| | notification to | Offer message may be requested | optimization |
| | the customer. | from other external sources | services |
| | The Delivery | Enables access and zero-rate billing | Occasion |
| | Agent is a | (e.g., for customers without data | trigger |
| | configurable | plans) | Provider APIs |
| | integration | | to enable |
| | framework for | | access and |
| | managing the | | zero-rate |
| | occasion trigger, | | billing (e.g., for |
| | retrieving the | | customers |
| | offer from the | | without data |
| | optimizer, and | | plans) |
| | delivering the | | Provider and |
| | offer through | | third-party |
| | the appropriate, | | widgets |
| | integrated | | Billing and/or |
| | delivery channel | | provisioning |
| | such as an | | APIs for |
| | SMSc or Push | | purchases |
| | Proxy Gateway. | | within widget |
| | | | that get billed |
| | | | by provider |
| | | | Provider or 3^{rd} |
| | | | party campaign |
| | | | management |
| | | | system |
| Reporting DB | Logs responses | Responses are logged to track | External |
| | and enables | which customers access which | reporting |
| | access to CMP | offers | service |
| | activity | Intercepts access outside of time | External data |
| | | boundaries (e.g., two weeks later; if | for enhanced |
| | | desired) and by other individuals | reporting |
| | | (e.g., if message is forwarded; | |
| | | opportunity for different handling | |
| | | for other provider customers vs. | |
| | | customers of other providers; if | |
| | | desired) | |
| | | Reports provide detailed insights | |
| | | used to evaluate success of | |
| | | occasions for adjustment and | |
| | | optimization of CMP | |
| Reporting | Allows a human | | |
| Graphical User | to interact with | | |
| Interface (GUI) | the Reporting | | |
| | DB to obtain | | |
| | various reports | | |
| | including | | |
| | custom reports | | |
| | from custom | | |
| | queries | | |
| Admin Graphical | Allows a human | | |
| User Interface | to define the | | |
| (GUI) | occasions | | |
| | output from the | | |
| | ethnographic | | |
| | research or | | |
| | other means of | | |
| | determination | | |
| | into an occasion | | |
| | within the | | |
| | software using a | | |
| | graphical | | |
| | administration | | |
| | interface. The | | |
| | administration | | |
| | interface | | |
| | provides natural | | |
| | language | | |
| | occasion | | |
| | definition and | | |
| | integrated | | |
| | results | | |
| | reporting. | | |

### Generalized Operation

The operation of certain additional general aspects of the invention will now be described with respect to FIG. 5: Process 500 of FIG. 5 may be performed, in one embodiment, by CMS 106 of FIG. 1. In another embodiment, at least a portion of process 500 may be performed within one or more of the components illustrated within FIG. 4.

Process 500 begins, after a start block, at block 502 and 504, independently. These processes may be run in parallel or sequentially, with or without direct interaction.

Processing block 502 describes where Networked Services Providers' data for one or a plurality of telecommunications network services provider customers is received. In one embodiment, the data is received based on a defined time period, event, or the like. For example, the data might be received hourly, daily, weekly, monthly, or even every minute or continuously. Moreover, the received data, as discussed above, includes historical and/or real-time data including customers' profiles, customer usage records, billing data, and the like. Processing moves next from block 502 to block 508.

Processing block 504 represents a process Of ethnographic research and anthropological modeling to identify a plurality of occasions appropriate for the cultural population. These occasions are prioritized and filtered to identify the highest quality occasions that have the highest likelihood of contextual relevance for and acceptance with the culturally unique subscriber group within the plurality of customers.

Continuing to block 506 from block 504, for each of the discovered occasions; one or more associated conditions/states are determined. In one embodiment, the conditions are input into the CMS using the admin GUI. However, the conditions/states may also be dynamically determined by the CMS. Additionally, for each of the conditions/states a confidence level is determined, where the confidence level is useable to identify whether the condition is detected/predicted.

Proceeding to block 508 from blocks 502 and/or 506, customer data, including customer profiles, usage data, purchase data, and external data are analyzed to detect various patterns, behaviors, and the like. The detected patterns, behaviors, and the like, are then useable for qualification of conditions that define the occurrence of an occasion uniquely for each customer. In this manner, for a given customer, the occasions relevant to the systematic ordering of conditions for which the customer is qualified are monitored, rather than seeking to monitor for occasions that might not be relevant to the customer. However, in another embodiment, all identified occasions across all conditions might be monitored for each customer.

It should be recognized that, patterns and behaviors for a given customer might change, resulting in a change in classification for the customer. Therefore, in one embodiment, classifications/re-Classifications of customers may be performed on a regular basis, such as continuously, daily, weekly, monthly, or the like. In this manner, patterns or behaviors that might be based on seasonal events may be detected.

Thus, at decision block 512, a determination is made whether an occasion has occurred. If so, processing flows to block 514; otherwise, processing loops back to block 502 to continue to receive and to analyze data.

At block 514, a plurality of contextual product/service offering(s) are determined for the customer based on the detected one or more target occasions. In one embodiment, a determination might be made whether the customer is eligible for the product/service. In one embodiment, each of the offering(s) may have calculated for them, for the particular customer, a value indicating a likelihood of that product/service being accepted by that customer. This value may be determined using a variety of analytics of the customer's behaviors, buying patterns, including prior purchases when previously provided an offering or the like for similar products/services. In one embodiment, the product/service offerings may be rank ordered based on their likelihood of acceptance by the customer. Those offerings having a likelihood of, acceptance below a threshold for acceptance may be deleted from the rank ordering, leaving those offering(s) that may be considered most likely to be accepted by the customer given the occasion.

In one embodiment, that offering having the highest likelihood of acceptance by the customer might be the only offering subsequently presented to the customer (under the condition that the offering also exceeds the threshold for acceptance). However, in another embodiment, multiple offerings might be presented to the customer. In still another embodiment, where two or more offerings have a likelihood of acceptance above the threshold, then that offer that maximizes a benefit to the provider might be selected.

In any event, as noted above, it might be that no offering has a likelihood of acceptance that exceeds the threshold. In that instance, in one embodiment, no offering might be, presented. Thus, proceeding to decision block 516, a determination is made whether at least one offer has a likelihood of acceptance above the threshold. If so, processing continues to block 518; otherwise, processing loops back to block 502 to continue receiving customer data and monitoring for the occurrence of an occasion.

At block 518, a message may be provided to the customer indicating that a product/service is available for the customer. In one embodiment, the message might be an SMS message; however, other mechanisms might be used, including, but not limited to a phone call, an email message, or virtually any other communication mechanism.

In one embodiment, a determination may be made whether the customer has selected to receive, purchase, be reminded later, reject, or ignore the product/service offering. In any event, the customer's profile and/or purchasing data may be updated to reflect the customer's decision. In this manner, likelihood of acceptances may be updated to reflect the customer's acceptability for offerings. Processing then loops back to block 502 to repeat process 500 and/or sub-blocks therein.

The analysis and/or classifications/re-classifications disclosed above may be performed periodically, or even aperiodically. Thus, as noted above, as a customer changes, such changes may be detected and used to re-classify the customer. Moreover, changes to a condition/state, occasion, and/or ethnographic group may be detected.

In any event, it will be understood that each block of the flowchart, and combinations of blocks in the flowchart, can be implemented by computer program instructions. These program instructions may be provided to a processor to produce a machine, such that the instructions, which execute on the processor, create means for implementing the actions specified in the block or blocks. The computer program instructions may be executed by a processor to cause a series of operational steps to be performed by the processor to produce a computer-implemented process such that the instructions, which execute on the processor to provide steps for implementing the actions specified in the block or blocks. The computer program instructions may also cause at least some of the operational steps shown in the blocks to be performed in parallel. Moreover, some of the steps may also be performed across more than one processor, such as might arise in a multi-processor computer system. In addition, one or more blocks or combinations of blocks in the illustration may also be performed concurrently with other blocks or combinations of blocks, or even in a different sequence than illustrated without departing from the scope or spirit of the invention.

Accordingly, blocks of the illustration support combinations of means for performing the specified actions, combinations of steps for performing the specified actions and program instruction means for performing the specified actions. It will also be understood that each block of the illustration, and combinations of blocks in the illustration, can be implemented by special purpose hardware-based systems, which perform the specified actions or steps, or combinations of special purpose hardware and computer instructions.

### Illustrated Non-Limiting, Non-Exhaustive Examples

The following provides non-limiting, non-exhaustive examples of how various embodiments might be employed to provide contextual offerings to a customer based in part on ethnographic analysis. It should be noted that the following examples are not to be construed as limiting the scope of the invention. Rather, they are merely provided to illustrate non-limiting examples of possible use of the invention, and thus are not exhaustive examples.

FIG. 6, for example, shows one non-limiting, non-exhaustive example of an occasion and related conditions as researched by anthropological processes. As shown, FIG. 6 illustrates possible conditions that may be determined from an analysis of telecom customer data As shown, the occasion represents a commuting professional as an ethnographic grouping using public transportation between home and work during weekdays. Therefore, the conditions illustrate who, how, what, where, and when. Each of these conditions may have an associated level of confidence threshold useable to determine when an occurrence of the occasion is to be detected for an individual customer. In one embodiment, the occurrence of the occasion detected or predicted to occur when analysis of a customer's data satisfies the confidence levels for each of the conditions. However, in another embodiment, the detection or prediction of an occurrence may be based on satisfying less than each of the conditions within their respective levels of confidence. For example, in one embodiment, three out of five confidence levels being satisfied might also be useable to detect or predict an occurrence of an occasion. Thus, the invention is not limited a particular number of confidence levels that must be satisfied, and other arrangements/combinations may also be used.

FIG. 7 illustrates another embodiment of a non-limiting, non-exhaustive example of possible occasion conditions.

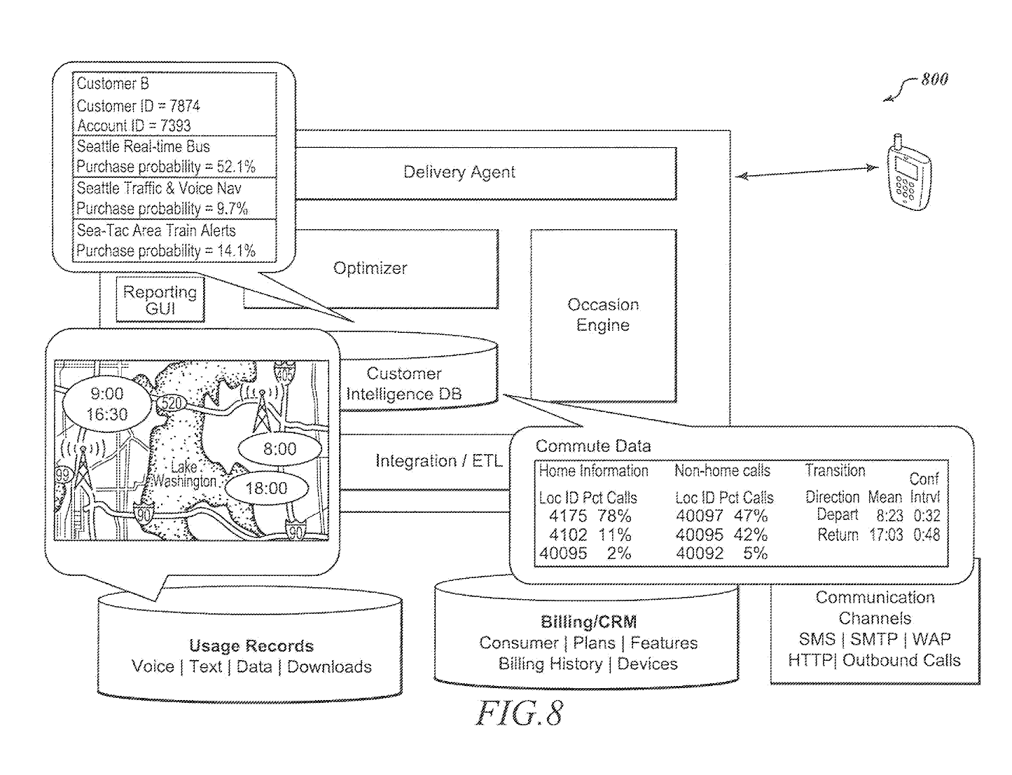

FIG. 8 illustrates one embodiment of data analysis useable to detect the occurrence of an occasion. As shown, usage data for a given customer is collected over time and analyzed. The data might provide information useable to predict a location of a grouping of network usage that indicate within a given confidence level to be a transition event, such as leaving home, leaving/arriving at work, or the like. Associated times are also obtained for such transition events. Based on the analysis, it might be determined that the customer is within the confidence levels, also a professional commuting on public transportation on a schedule. The schedule might indicate a transition of relative communication location around 8:00 AM, 9:00 AM, and again around 16:30 PM, and 18:00 PM. Such communication transition may be associated with a statistical likelihood of leaving home around 7:51 AM, arriving to work around 8:55 AM, within a given confidence level. Again, such information may be obtained by analysis of historical telecom usage data, rather than detecting a precise and real-time occurrence of activities by the customer. Moreover, such data may be analyzed over time to increase a level of confidence that the customer satisfies a particular occasion.

Usage of the historical telecom data may then provide within a given confidence level(s), a predicted occurrence of an occasion. When the occurrence of the occasion is then predicted—that is—for example, it is determined that the time is about 7:51 AM on a weekday, for the given customer, then the detected occurrence is provided to the optimizer to select a possible offering for the customer. In one embodiment, additional information about the customer's network usage behavior, purchasing trends, and the like, may be used to select the appropriate offering for the given customer and predicted occasion. Then, if the offering has a threshold of likelihood of acceptance for the given customer and occasion, the offering is pushed to the customer during the detected occasion or slightly before its predicted occurrence. For example, if it is predicted that the customer leaves home at 7:51 AM, it might be appropriate to push the offering slightly before that time, when the offering is more likely to be viewed. Moreover, the customer might also be more receptive to an offering that is provided slightly before the occurrence, rather than after the occurrence.

For example, consider where the customer might have a desire to know whether the bus is late today, or early, providing such information once the customer has left their home might be less valuable, than providing it slightly before they are likely to leave their home. Thus, providing the customer with an application that indicates where the bus currently is on today's route would be more useful before the customer leaves their home. In another embodiment, knowing whether the bus is late or early would provide additional options to the customer. For example, the customer might wish to take extra time, if they knew it was available to them, to obtain a cup of coffee. Such timely delivery Of such an application based on the predicted occurrence of the occasion provides increased benefits to the customer and increases the likelihood that the offering will be accepted.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device, comprising:
a transceiver to send and receive data over a network; and
a processor that is operative to perform actions, comprising:
performing ethnographic research and anthropological modeling on a plurality of customers to identify a plurality of occasions having a contextual relevance for acceptance above a threshold for the plurality of customers;
receiving networked services provider telecommunications data for the plurality of customers;
performing continuously statistical, behavioral, and predictive analytics upon the networked services provider telecommunications data to detect an occurrence of at least one occasion within the plurality of identified occasions for a customer within the plurality of customers, wherein the detection of the occurrence is based on at least one condition for the occasion being determined to be satisfied above an associated confidence level for the customer;
when an occurrence is detected for the customer, selecting at least one product and/or service based on the detected occurrence and the customer; and
selectively providing an offering for the at least one product/service to the customer.

2. The network device of claim 1, wherein selectively providing an offer further comprises:
if likelihood of acceptance for at least one product or service is above a threshold, providing a message to the customer offering the at least one product or service; otherwise,
inhibiting sending of an offering of a product or service to the customer.

3. The network device of claim 1, wherein selectively providing an offer further comprises:
if at least two products and/or services have a likelihood of acceptance above a threshold:
selecting one of the products or services having a greatest financial value to the networked services provider, and
sending an offering to the customer for the selected one of the products or services.

4. The network device of claim 1, wherein the contextual relevance for acceptance is determined based on an ethnographical grouping of the customers.

5. The network device of claim 1, wherein detecting an occurrence of at least one occasion further comprises predicting when, and where the occasion is to occur for the customer.

6. The network device of claim 1, wherein detecting an occurrence of at least one occasion further comprises having a plurality of conditions associated with the occasion, and wherein each of the conditions are determined to be satisfied within a respective confidence level.

7. The network device of claim 1, wherein selectively providing an offering further comprises, if a plurality of products and/or services has a likelihood of acceptance above a threshold, providing an offering for each of the plurality of products and/or services to the customer.

8. A method operating on a computer device for use in targeting a telecommunications offer to a customer, the method comprising:
performing ethnographic research and anthropological modeling on a plurality of customers to identify a plurality occasions having a contextual relevance for acceptance above a threshold for the plurality of customers;
receiving networked services provider telecommunications data for the plurality of customers;
performing continuously statistical, behavioral, and predictive analytics upon the networked services provider telecommunications data to detect an occurrence of at least one occasion within the plurality of identified occasions for a customer within the plurality of customers, wherein the detection of the occurrence is based on at least one condition for the occasion being determined to be satisfied above an associated confidence level for the customer;
when an occurrence is detected for the customer, selecting at least one product and/or service based on the detected occurrence and the customer; and
selectively providing an offering for the at least one product/service to the customer.

9. The method of claim 8, wherein selectively providing an offer further comprises:
if likelihood of acceptance for at least one product or service is above a threshold, providing a message to the customer offering the at least one product or service; otherwise,
inhibiting sending of an offering of a product or service to the customer.

10. The method of claim 8, wherein selectively providing an offer further comprises:
if at least two products and/or services have a likelihood of acceptance above a threshold:
selecting one of the products or services having a greatest benefit to the telecommunications networked services provider, and
sending an offering to the customer for the selected one of the products or services.

11. The method of claim 8, wherein detecting an occurrence of at least one occasion further comprises predicting when, and where the occasion is to occur for the customer.

12. The method of claim 8, wherein detecting an occurrence of at least one occasion further comprises having a plurality of conditions associated with the occasion, and wherein each of the conditions are determined to be satisfied within a respective confidence level.

13. The method of claim 8, wherein selectively providing an offering further comprises, if a plurality of products and/or services has a likelihood of acceptance above a threshold, providing an offering for each of the plurality of products and/or services to the customer.

14. A system of targeting a telecommunications offer to a customer, comprising:
a telecommunications data store having a plurality of customer data; and
a network device configured to receive at least some of the plurality of customer data and to perform actions, including:
performing ethnographic research and anthropological modeling on the plurality of customers to identify a plurality occasions having a contextual relevance for acceptance above a threshold for the plurality of customers;
receiving networked services provider telecommunications data for the plurality of customers;
performing continuously statistical, behavioral, and predictive analytics upon the networked services provider telecommunications data to detect an occurrence of at least one occasion within the plurality of identified occasions for a customer within the plurality of customers, wherein the detection of the occurrence is based on at least one condition for the occasion being determined to be satisfied above an associated confidence level for the customer;
when an occurrence is detected for the customer, selecting at least one product and/or service based on the detected occurrence and the customer; and
selectively providing an offering for the at least one product/service to the customer.

15. The system of claim 14, wherein selectively providing an offer further comprises:
if likelihood of acceptance for at least one product or service is above a threshold, providing a message to the customer offering the at least one product or service; otherwise,
inhibiting sending of an offering of a product or service to the customer.

16. The system of claim 14, wherein selectively providing an offer further comprises:
if at least two products and/or services have a likelihood of acceptance above a threshold:
selecting one of the products or services having a greatest financial value to the telecommunications networked services provider, and
sending an offering to the customer for the selected one of the products or services.

17. The system of claim 14, wherein detecting an occurrence of at least one occasion further comprises predicting when, and where the occasion is to occur for the customer.

18. The system of claim 14, wherein detecting an occurrence of at least one occasion further comprises having a plurality of conditions associated with the occasion, and wherein each of the conditions are determined to be satisfied within a respective confidence level.

19. The system of claim 14, wherein selectively providing an offering further comprises, if a plurality of products and/or services has a likelihood of acceptance above a threshold, providing an offering for each of the plurality of products and/or services to the customer.

20. The system of claim 14, wherein performing the ethnographic research and anthropological modeling is performed substantially concurrently with receiving the networked services provider data.
